(19) United States
(12) Patent Application Publication
(10) Pub. No.: US 2003/0047059 A1
(43) Pub. Date: Mar. 13, 2003

(54) Indoor/outdoor musical wind chime

(76) Inventor: Robert Stanton Brown JR., Lunenburg, MA (US)

Correspondence Address: ROBERT S. BROWN, JR., 158 ROLLING ACRES ROAD, LUNENBURG, MA, 01462, US

(21) Appl. No.: 10/236,236

(22) Filed: Sep. 6, 2002

Related U.S. Application Data
(60) Provisional application No. 60/318,017, filed on Sep. 7, 2001.

(51) Int. Cl. G10D 13/08

(52) U.S. Cl. 84/402

(57) ABSTRACT

A musical wind chime that can be placed in any indoor or outdoor environment where there is air movement and the musical wind chime will be activated regardless of the source of the air movement or the direction the air movement comes from. The inventive device includes a chime tether consisting of ball chain and ball chain connectors; a chime rod hanging structure which suspends on the ball chain and to which the chime rods are attached; a striker and a baffle mechanism attached to the lower portion of the ball chain. Air movement from any direction hits the baffle, causing the baffle to move which in turn causes the striker to contact the chime rods.

### BACKGROUND OF THE INVENTION

1. Field of the Invention

The present invention relates generally to musical wind chimes and more specifically it relates to an indoor/outdoor musical wind chime that can be placed in any indoor or outdoor environment where there is air movement and the musical wind chime will be activated regardless of the source of the air movement or the direction the air movement comes from.

2. Description of the Prior Art

Musical wind chimes have been in use for years and the basic construction of these devices has remained essentially unchanged. Musical wind chimes generate sound using chime rods suspended in such a way that they vibrate when struck by another object. The chime rods can be made of various materials, usually metal or wood, and can be solid bars or hollow tubes. Typically, a musical wind chime is placed outdoors and is hung from a flexible tether so the length of the chime rods is roughly perpendicular to the plane of the earth's surface. The chime is activated by breezes moving more or less horizontal to the plane of the earth's surface. These breezes push a baffle suspended on a string or cord adjacent to the chime rods, generating a pendulum action that moves a striker which is also attached to the string or cord. The striker in turn hits the chime rods. In either case, the chime rods vibrate and create musical notes.

The main problem with conventional musical wind chimes is that air movement coming from above or below the chimes will not effectively push the baffles or the chime rods to activate the chimes. In the existing art of musical wind chimes, both those with and without baffles, activation of the chimes is from naturally created air movement which is typically blowing into the chime from the side and not the top or bottom. Therefore, existing chimes do not work well in situations where air movement is not from the side. An example of this would be hanging a chime designed using prior art underneath a ceiling fan with the air movement blowing into the chime from the top—the chime would not be activated.

Prior art has addressed improvements in activating chimes using various baffles and strikers. A rotating striker is disclosed in U.S. Pat. No. 5,648,624 and a humming bird activated chime is disclosed in U.S. Pat. No. 6,103,962. Prior art has also addressed incorporating mechanisms into chimes to generate motion when or where there is no natural breeze. A vertical draft mechanism is disclosed in U.S. Pat. No. 6,441,284. There is a solar activated U.S. Pat. No. 5,208,578; a water activated U.S. Pat. No. 6,166,310; and various electromechanical and electromagnetic driven devices U.S. Pat. Nos. 6,417,763 and 6,124,539 and 5,831,516 and 5,072,208. None of this prior art discloses a wind chime that is activated by air movement striking the wind chime from any direction.

Another problem with conventional musical wind chimes is that the string or cord used to tether the baffle to the chime can wear and/or deteriorate over time and with extended use. This string or cord will then break and must be repaired or replaced.

While the existing devices may be suitable for the particular purpose to which they address, they are not as suitable for providing a musical wind chime that can be placed in any indoor or outdoor environment where there is air movement and the musical wind chime will be activated regardless of the source of the air movement or the direction the air movement comes from. In these respects, the indoor/outdoor musical wind chime according to this invention substantially departs from the conventional concepts and designs of the prior art.

### SUMMARY OF THE INVENTION

In view of the foregoing disadvantages inherent in the known types of musical wind chimes now present in the prior art, this invention provides a new indoor/outdoor musical wind chime construction that can be placed in any indoor or outdoor environment where there is air movement and the musical wind chime will be activated regardless of the source of the air movement or the direction the air movement comes from.

The general purpose of this invention is to provide a new indoor/outdoor musical wind chime that has many of the advantages of the musical wind chimes mentioned heretofore and many novel features that result in a new indoor/outdoor musical wind chime which is not anticipated, rendered obvious, suggested, or even implied by any of the prior art for musical wind chimes, either alone or in combination thereof.

To attain this, this invention generally comprises a chime tether consisting of two length of ball chain connected by a ball chain connector and with ball chain connectors attached to each end, a chime rod hanging structure which suspends on the ball chain and to which the chime rods are attached, a striker attached to the lower portion of the ball chain, and a baffle mechanism consisting of a baffle and an axle. The baffle mechanism is constructed to be sensitive to air movement from any direction. When the baffle is moved by the air, it in turn moves the striker which contacts the chime rods causing the chime rods to vibrate and generate musical notes.

This invention is not limited in its application to the details of construction and to the arrangements of the components set forth in the following description or illustrated in the drawings. This invention is capable of other embodiments and of being practiced and carried out in various ways. Also, it is to be understood that the phraseology and terminology employed herein are for the purpose of the description and should not be regarded as limiting.

A primary object of this invention is to provide an indoor/outdoor musical wind chime that will overcome the shortcomings of the prior art devices.

An object of this invention is to provide an indoor/outdoor musical wind chime that has a new and unique construction that facilitates the activation of the chime by air movement striking it from any direction, including from above or below the chime, as well as from the sides. This invention allows the musical wind chime to be physically hung and positioned and used as a traditional outdoor wind chime, but more importantly, it permits the musical wind chime to be positioned and activated effectively anywhere there is air movement, regardless of the direction of the air movement. Thus, this musical wind chime can be used indoors in situations such as, but not limited to, positioning it underneath or near ceiling fans; placing it adjacent to air conditioners, vents or blowers; hanging it in the draft created by open windows or doors; essentially anywhere there is air movement of any kind.

Another object of this invention is to provide a baffle mechanism that is highly sensitive to air movement from any direction.

Another object is to provide an indoor/outdoor musical wind chime that utilizes a baffle and striker tether made of metal ball chain rather than string or cord, thus providing a stronger construction that is less likely to deteriorate or break.

Another object is to provide a highly stable chime rod hanging structure so that chime various lengths and weights can be hung from it without causing it to tilt.

Another object is to provide an indoor/outdoor musical wind chime that can be easily attached to the pull chains of commercially available ceiling fans and lights. Most ceiling fan pull chains are constructed of ball chain and this invention utilizes ball chain and ball chain connectors not only as the baffle and striker tether, but also as the main tether for the chime itself.

Other objects and advantages of this invention will become obvious to the reader and it is intended that these objects and advantages are within the scope of this invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the indoor/outdoor musical wind chime assembly.

FIG. 2 is the tether for the chime itself and for the baffle mechanism and striker.

FIG. 3 is the baffle mechanism, including the baffle and axle.

FIG. 4 is the chime rod hanging structure, including the hanger and the chime rods.

FIG. 5 is the striker.

### DETAILED DESCRIPTION OF THE INVENTION

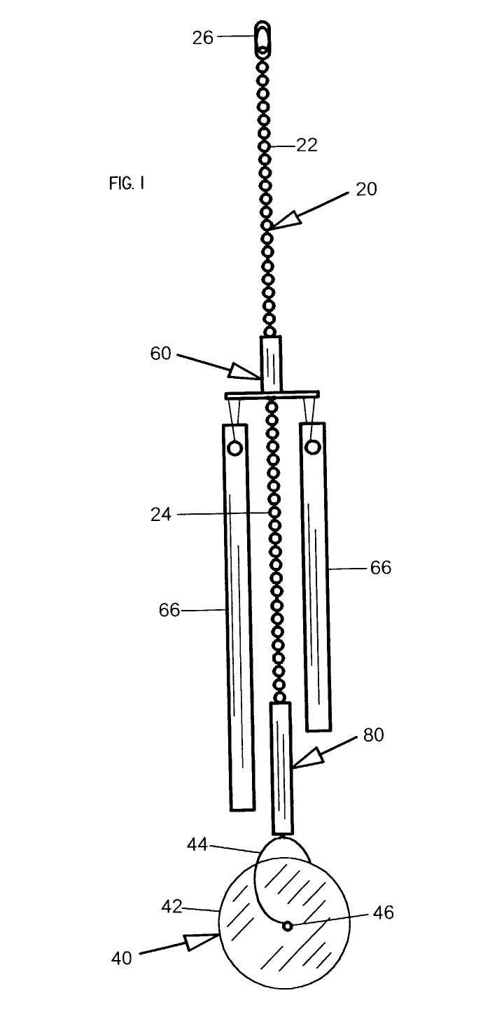

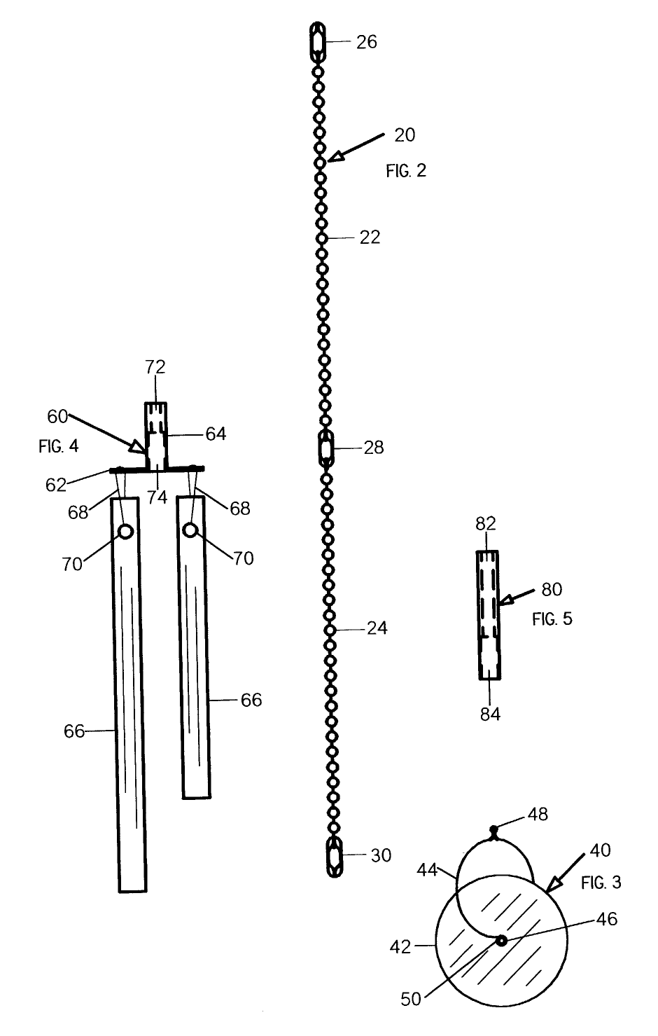

Turning descriptively to the drawings, in which similar reference characters denote similar elements throughout the several views, the attached figures illustrate an indoor/outdoor musical wind chime, which comprises a chime tether 20 in FIG. 2 consisting of two lengths of ball chain 22 and 24 connected by a ball chain connector 28 and with ball chain connectors 26 and 30 attached to each end; a chime rod hanging structure 60 in FIG. 4 which suspends on the ball chain connector 28 in FIG. 2 and to which the chime rods 66 in FIG. 4 are attached; a striker 80 in FIG. 5 which suspends on the ball chain connector 30 in FIG. 2; and a baffle mechanism 40 in FIG. 3 consisting of a baffle 42 and an axle 44 which is attached to the ball chain connector 30 in FIG. 2 by the terminal ends of the baffle axle 48 in FIG. 3. The aforementioned components are shown fully assembled in FIG. 1.

The chime tether 20 in FIG. 2 is two sections of ball chain 22 and 24 attached together by a ball chain connector 28. At each end of the ball chain 22 and 24, there also resides connectors 26 and 30. The chime tether 20 is the backbone of the chime. It is used to hang the chime itself and the upper connector 26 can be used to attach the chime to the pull chain of a commercially available ceiling fan or light. The connector 28 that joins the two sections of ball chain 22 and 24 is the support upon which the chime rod hanging structure 60 in FIG. 4 rests. The lower connector 30 in FIG. 2 is the support upon which the striker 80 in FIG. 5 rests and it also holds the terminal ends of the baffle axle 48 in FIG. 3. The chime tether 20 in FIG. 2 can also be made from any thin flexible material such as organic or synthetic string or cord or metal wire.

The chime rod hanging structure 60 in FIG. 4 is a flat disk 62 with holes around its circumference. The circumference holes are used to attach a plurality of chime rods 66 using natural or synthetic strings or cords 68. Integral to the flat disk 62, centered and extending above its flat surface, is a shaft 64. The ball chain 22 in FIG. 2 extends through the hole in the shaft 64 and disk 62. The hole in shaft 64 and disk 62 has two dimensions. The upper dimension 72 has a diameter that fits the width of the ball chain 22 in FIG. 2 while the lower dimension 74 has a diameter that fits the larger width of the connector 28 in FIG. 2. As such, the chime rod hanging structure 60 rests on the connector 28 in FIG. 2. With this construction, the chime rod hanging structure 60 is very stable and will not tilt, even when chime rods 66 hanging from it vary greatly in length and therefore weight. The chime rod hanging structure 60 can be constructed of any material. It does not have to take the shape of a disk but could be other shapes including any structure from which the chime rods 66 can hang and be extended away from the tether 24 in FIG. 2 and striker 80 in FIG. 5.

The striker 80 in FIG. 5 is a cylinder which hits the chime rods 66 in FIG. 4 and causes them to vibrate and make musical notes. The lower ball chain 24 in FIG. 2 extends through a hole running the length of the striker 80. The width of the hole in striker 80 has two dimensions. The upper dimension 82 has a diameter that fits the width of the ball chain 24 in FIG. 2 while the lower dimension 84 has a diameter that fits the larger width of the connector 30 in FIG. 2 at the bottom of the lower ball chain 24. As such, the striker 80 rests on the connector 30 in FIG. 2. The length of the striker 80 is such that it can, as it moves from side to side, contact each chime rod 66 in FIG. 4 regardless of the chime rod's 66 length. The striker 80 can be made of any hard material and can be of various shapes and sizes.

The baffle mechanism 40 in FIG. 3 positions a thin, flat, lightweight wafer-like baffle 42 on an axle 44. The size of the baffle 42 must be sufficient to catch air movement, especially when the air movement is from above the chime which itself can deflect air movement away from the baffle 42. The axle 44 is a small-diameter wire-like filament structure that carries the baffle 42 by means of a small hub hole 46 centered in the baffle 42. The axle 44 also has a centered low point 50 on which the baffle 42 naturally rests due to gravity. The ends of axle 44 are extended upward and are joined to the ball chain connector 30 in FIG. 2. With the ends of the axle 44 extended upward, the outside edge of baffle 42 can hit the extended ends of axle 44 and baffle 42 is thus limited as to how far it can pivot from side to side. The baffle 42 can be many shapes, governed only by the necessity that it have enough surface to catch air movement and that it can be balanced on axle 44. The baffle 42 can be made of any lightweight rigid or semi-rigid material. The axle 44 can be constructed of various materials and can have multiple sections.

This invention is designed to be used in any outdoor or indoor environment where there is air movement. Referencing the Indoor/Outdoor Musical Wind Chime Assembly in FIG. 1, the ball chain tether 20 enables not only a strong construction, but with connector 26 allows the chime to be hung from the pull chains of ceiling fans and lights, many of which are commercially available in ball chain format. Air movement from any direction hits the baffle 42 and the baffle 42 begins to pivot on axle 44. The baffle 42 pivot motion is purposely restricted as its outer edge hits the upward extensions of the axle 44. Momentum is created and the baffle 42 pivots back and forth. With the baffle 42 and the striker 80 suspended off the lower section of ball chain 24, the pivoting of the baffle 42 generates a pendulum action and the striker 80 begins to move. As the striker 80 moves side to side, it hits an adjacent chime rod 66, causing the chime rod 66 to vibrate. The human ear hears this vibration as a musical note. Due to the variations in air movement as well as changes in momentum caused by the striker 80 hitting chime rods 66, the striker 80 contacts the chime rods 66 randomly. Since the lengths of the chime rods 66 vary to generate different musical notes, the striker 80 is designed with enough length to contact any length chime rod.

With respect to the above description, it is to be realized that the optimum dimensional relationships for the parts and components of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by this present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A wind chime assembly, comprising:
(a) a baffle mechanism;
(b) a striker;
(c) a chime rod hanging structure;
(d) a plurality of chime rods hanging from the chime rod hanging structure;
(e) a tether to which the baffle mechanism, the striker, and the chime rod hanging structure are attached;
whereby said baffle mechanism, when activated by air movement from any direction, moves the striker into contact with the chime rods causing the chime rods to vibrate.

2. A baffle mechanism, comprising:
(a) a baffle;
(b) an axle;
whereby the axle extends through a hole in the baffle with the hole positioned such as to balance the baffle and allow the baffle to pivot.

3. A wind chime tether, comprising:
(a) ball chain;
(b) ball chain connectors;
whereby the ball chain properly positions the components of the wind chime, the ball chain connectors support the components of the wind chime, and a ball chain connector can connect the wind chime assembly to the pull chains of ceiling fans and lights.
